(19) United States
(12) Patent Application Publication
(10) Pub. No.: US 2026/0061748 A1
(43) Pub. Date: Mar. 5, 2026

(54) LIQUID EJECTION HEAD AND LIQUID EJECTION BOARD

(71) Applicant: CANON KABUSHIKI KAISHA, Tokyo (JP)

(72) Inventors: AKIKO HAMMURA, Tokyo (JP); YOSHIYUKI NAKAGAWA, Kanagawa (JP); AYAKO MARUYAMA, Kanagawa (JP)

(21) Appl. No.: 19/310,291

(22) Filed: Aug. 26, 2025

(30) Foreign Application Priority Data
Aug. 27, 2024 (JP) 2024-145597

(51) Int. Cl. B41J 2/14; B41J 2/045; B41J 2/175

(52) U.S. Cl. CPC B41J 2/14233; B41J 2/04581; B41J 2/175

(57) ABSTRACT

A liquid ejection head includes lamination in the enumerated order of an ejection port forming board including ejection ports that eject a liquid, a pressure chamber forming board including pressure chambers which are provided corresponding to the respective ejection ports and contain the liquid to be ejected from the ejection ports, a liquid supplying board including a first common flow channel communicating with a first number of the pressure chambers in common and a second common flow channel communicating with a second number, which is smaller than the first number, of the pressure chambers in common, and a damper region forming board including a first damper region for reducing a pressure fluctuation in the first common flow channel and a second damper region for reducing a pressure fluctuation in the second common flow channel. The first damper region is larger than the second damper region.

### BACKGROUND

### FIELD OF THE TECHNOLOGY

The present disclosure relates to a liquid ejection head and a liquid ejection board.

### DESCRIPTION OF THE RELATED ART

In a liquid ejection head designed to eject a liquid, a pressure fluctuation may develop inside a pressure chamber in association with ejection of the liquid and the pressure fluctuation may be propagated to another pressure chamber through a liquid flow channel, thereby possibly causing so-called crosstalk that may affect ejection characteristics. In a case where the crosstalk is caused, an ejection speed and an ejection volume at each ejection element may become unstable, and there is a possibility to adversely affect images.

Japanese Patent Laid-Open No. 2019-155909 (hereinafter referred to Document 1) discloses a configuration to provide a damper to a liquid flow channel that communicates with multiple pressure chambers in common, thereby absorbing pressure fluctuations from the pressure chambers and suppressing crosstalk.

An effect of the damper to suppress the pressure fluctuations depends on the number of the pressure chambers communicating with the damper. However, according to the configuration of the Document 1, multiple dampers of the same size are prepared whereas the numbers of the pressure chambers to be connected to the respective dampers are not constant. Accordingly, sufficient effects to suppress the crosstalk are not available in some ejection elements and a liquid ejection head may be unable to stably carry out normal ejecting operations as a whole.

### SUMMARY

Given the circumstances, it is an object of the present disclosure to provide a liquid ejection head which is capable of stably carrying out a normal ejecting operation.

A liquid ejection head according to an aspect of the present disclosure includes lamination in the enumerated order of an ejection port forming board including multiple ejection ports and configured to eject a liquid, a pressure chamber forming board including multiple pressure chambers provided corresponding to the respective ejection ports and configured to contain the liquid to be ejected from the ejection ports, a liquid supplying board including a first common flow channel communicating with a first number of the pressure chambers in common and a second common flow channel communicating with a second number, which is smaller than the first number, of the pressure chambers in common, and a damper region forming board including a first damper region for reducing a pressure fluctuation in the first common flow channel and a second damper region for reducing a pressure fluctuation in the second common flow channel. Here, the first damper region is larger than the second damper region.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram schematically showing a printing apparatus;

FIGS. 2A to 2C are diagrams to explain a liquid ejection head;

FIGS. 3A to 3C are diagrams to explain a liquid ejection board of a first embodiment;

FIGS. 4A and 4B are diagrams to explain a liquid ejection board of a second embodiment;

FIGS. 5A to 5C are diagrams to explain a liquid ejection board of a third embodiment;

FIGS. 6A to 6C are diagrams to explain a liquid ejection board of a fourth embodiment; and

FIGS. 7A and 7B are plan views of respective boards constituting a liquid ejection board.

### DESCRIPTION OF THE EMBODIMENTS

Preferred embodiments of the present disclosure will be described below in detail with reference to the accompanying drawings. It is to be noted that the following embodiments are not intended to limit the subject matters of the present disclosure, and that the entire combination of the features described in each of the following embodiments is not always essential for a solution of the present disclosure.

### FIRST EMBODIMENT

A liquid ejection head and a liquid ejection apparatus according to the present embodiment will be described below with reference to the drawings. Although the present embodiment will describe a liquid ejection head and an ink jet printing apparatus which eject inks as examples, the present disclosure is not limited to these examples. The liquid ejection head and the liquid ejection apparatus of the present disclosure are applicable to apparatuses including a printer, a copier, a facsimile provided with a communication system, a word processor including a printer unit, and the like, and to industrial printing apparatuses compositely combined with various processing apparatuses. For example, the present disclosure can also be employed for use applications including biochip fabrication, electronic circuit printing, and so forth. In the meantime, the liquids to be ejected are not limited only to the inks.

### OUTLINE OF PRINTING APPARATUS

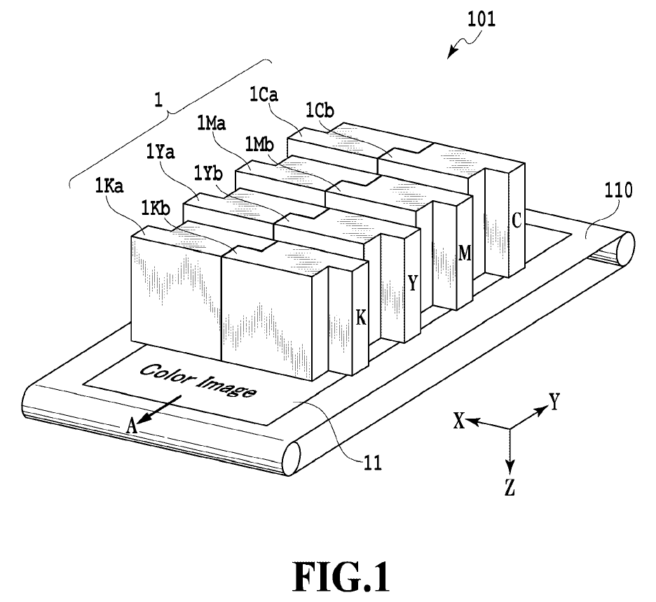

FIG. 1 is a diagram schematically showing a printing apparatus 101 which represents an example of a liquid ejection apparatus of the present embodiment. The printing apparatus 101 is a printing apparatus 101 of one pass type configured to print an image on a print medium 11 by moving the print medium 11 in a direction of an arrow A relative to a liquid ejection head module 1 (hereinafter referred to as a liquid ejection head 1). The liquid ejection head 1 is provided with ejection ports (also referred to as nozzles) which are arrayed in x direction across a region corresponding to a width of the print medium 11. The liquid ejection head 1 of the present embodiment is the head that supports four colors of cyan (C), magenta (M), yellow (Y), and black (K). To be more precise, the liquid ejection head 1 includes liquid ejection heads 1Ca and 1Cb that support a cyan (C) ink as well as liquid ejection heads 1Ma and 1Mb that support a magenta (M) ink. Moreover, the liquid ejection head 1 includes liquid ejection heads 1Ya and 1Yb that support a yellow (Y) ink as well as liquid ejection heads 1Ka and 1Kb that support a black (K) ink. Note that the printing apparatus 101 shown in FIG. 1 is a mere example, and the printing apparatus 101 may be configured to be capable of mounting a liquid ejection head 1 of an arbitrary mode. For example, the printing apparatus 101 may include a liquid ejection head that supports only one type or may include a liquid ejection head that supports multiple types other than the four types.

### CONFIGURATION OF LIQUID EJECTION HEAD

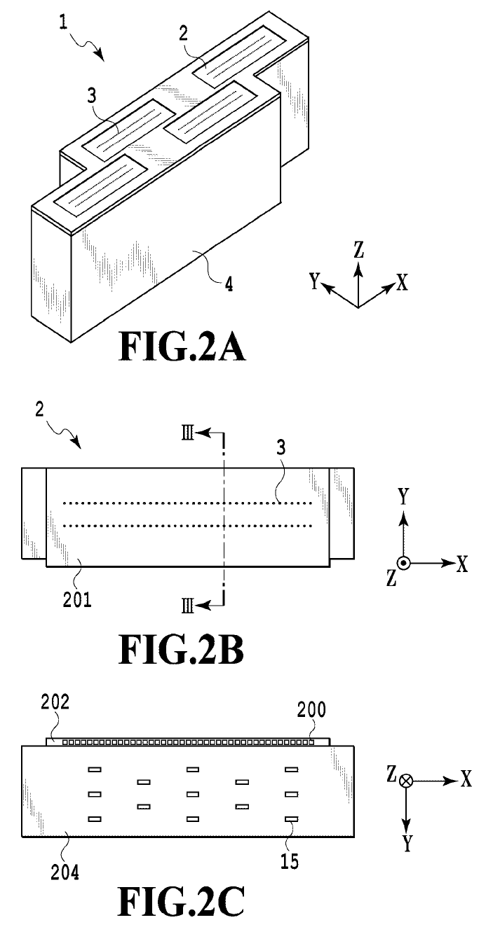

FIGS. 2A to 2C are diagrams to explain the liquid ejection head 1 of the present embodiment. FIG. 2A is a perspective view of the liquid ejection head 1 corresponding to an arbitrary color out of those shown in FIG. 1. The liquid ejection head 1 includes multiple liquid ejection boards 2 and a head body 4. The multiple liquid ejection boards 2 are disposed on the head body 4 (four liquid ejection boards 2 are disposed in FIG. 2A). Each liquid ejection board 2 is provided with multiple ejection ports 3. An ink ejected from the liquid ejection head 1 is supplied from an ink tank (not shown) to the liquid ejection board 2 through a common supply port (not shown) of the head body 4. The liquid ejection boards 2 are disposed such that end portions of the ejection ports 3 arrayed in x direction overlap one another in y direction. By disposing the liquid ejection boards 2 as described above, it is possible to carry out printing with an elongated ejection port array.

FIG. 2B is a diagram of the liquid ejection board 2 viewed from a surface on which the ejection ports 3 are arrayed. FIG. 2C is a diagram of the liquid ejection board 2 viewed from an opposite surface of the surface on which the ejection ports 3 are arrayed. The liquid ejection board 2 is formed by using multiple boards. As shown in FIG. 2B, the liquid ejection board 2 includes an ejection port forming board 201. The ejection port forming board 201 is provided with the ejection ports 3. The multiple ejection ports 3 are disposed in a longitudinal direction (the x direction, a first direction) of the liquid ejection board 2 (the ejection port forming board 201), thus forming an ejection port row. Meanwhile, in the ejection port forming board 201, the multiple ejection port arrays that extend in the longitudinal direction of the board are arranged in a direction crossing the direction along the ejection port row, that is to say, in a short side direction (the y direction, a second direction) of the board.

As shown in FIG. 2C, a flow channel forming board 204 is provided to the surface of the liquid ejection board 2 being opposite of the surface on which the ejection ports 3 are provided. The flow channel forming board 204 is provided with multiple connection ports 15. The liquid ejection head 1 of the present embodiment is configured to circulate the ink. The ink is supplied to the liquid ejection board 2 and the liquid is collected from the liquid ejection board 2 through the connection ports 15 formed in the flow channel forming board 204. The ink supplied to the liquid ejection board 2 passes through flow channels inside the board, and ejected from the ejection ports 3 in accordance with ejection signals so as to attach to the print medium 11.

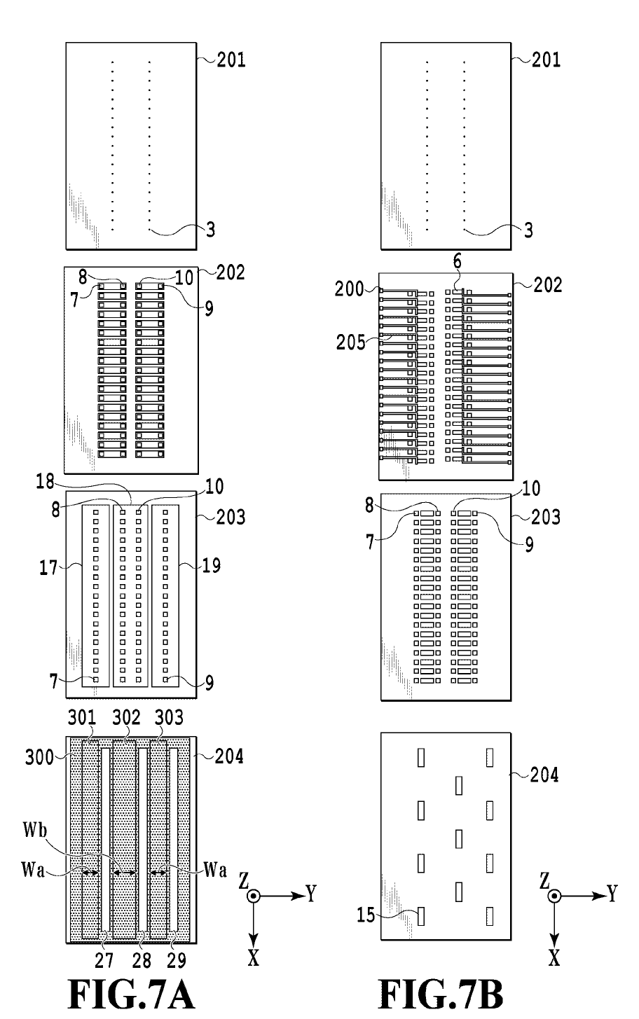

An electric board (not shown) for supplying electric power and signals necessary for ejecting the inks from the ejection ports 3 is disposed at the head body 4, which is connected to respective terminals 200 of the liquid ejection boards 2 through wiring 205 (see FIG. 7B). Note that the example explained with reference to FIGS. 2A to 2C is a mere example of the present embodiment, and the liquid ejection head 1 can be configured with a discretionary mode.

### Configuration of Liquid Ejection Board

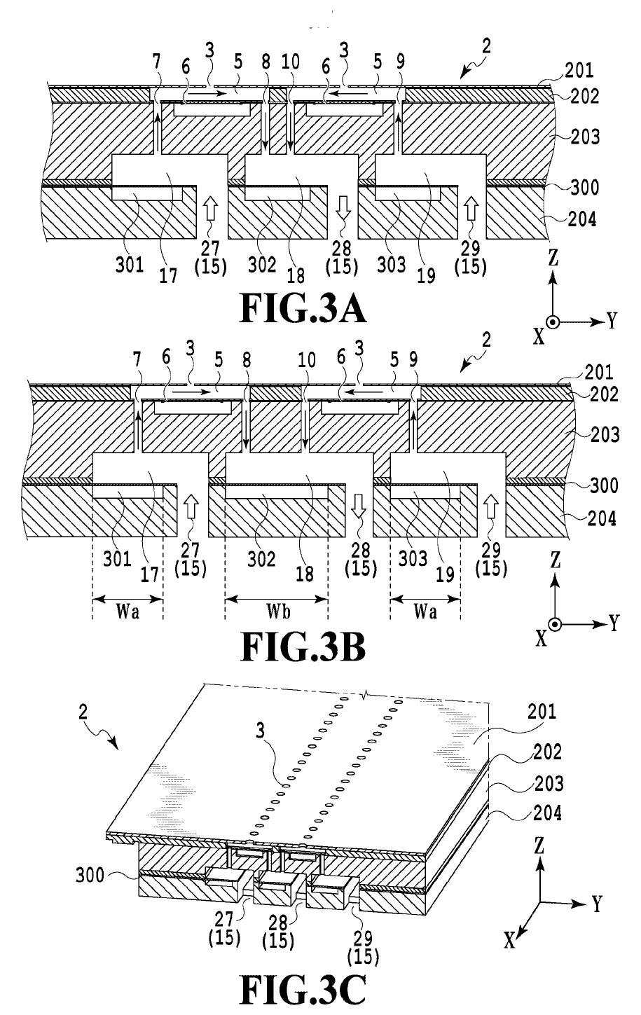

FIGS. 3A to 3C are diagrams for explaining the liquid ejection board 2 of the present embodiment in comparison with a comparative example. FIGS. 3A and 3B show cross-sectional views taken along the III-III line in FIG. 2B. FIG. 3A shows a configuration of the related art as the comparative example, which is unlikely to suppress crosstalk. FIG. 3B shows a configuration of the present embodiment which suppresses crosstalk. FIG. 3C is a diagram showing a perspective view of the cross-section taken along the III-III line in FIG. 2B.

As shown in FIGS. 3A to 3C, the liquid ejection board 2 of the present embodiment is formed from a laminated structure of multiple boards. To be more precise, the liquid ejection board 2 includes the ejection port forming board 201, a vibrating board 202, a liquid supplying board 203, the flow channel forming board 204, and a damper member 300. Each of the ejection port forming board 201, the vibrating board 202, the liquid supplying board 203, and the flow channel forming board 204 can be formed from a silicon substrate and the like. Although the present embodiment will discuss an example in which the respective boards are separate boards, the present disclosure is not limited to the configuration to provide the separate boards.

The damper member 300 is formed from an elastic member, which can apply a resin member like polyimide and polyamide, for example. Dry etching is cited as a method of providing the damper member 300 with openings. Meanwhile, in the case where the damper member is formed from a photosensitive resin, the damper member may be subjected to patterning by light exposure.

The case of applying the general configuration of the related art to the liquid ejection board 2 of the present embodiment will be described by using FIG. 3A. In FIG. 3A, arrows therein indicate directions of flows of the liquid.

The ejection port forming board 201 is provided with the ejection ports 3. The vibrating board (also referred to as a pressure chamber forming board) 202 is provided with pressure chambers 5 that communicate with the ejection ports 3. Meanwhile, piezoelectric elements 6 are provided at portions of the vibrating board 202 opposed to the ejection ports 3. Each piezoelectric element 6 is deformed by receiving voltage application, thus pressurizing the liquid inside the pressure chamber 5 and ejecting the ink from the ejection port 3. One pressure chamber 5 and one piezoelectric element 6 correspond to each ejection port 3. The aforementioned set of the ejection port 3, the pressure chamber 5, and the piezoelectric element 6 will be referred to as an "ejection element" in the present disclosure for the sake of convenience.

Multiple ejection elements are arrayed in the x direction, thus forming one ejection element row. The present embodiment adopts a configuration in which two ejection element rows as mentioned above are arranged in parallel in the y direction. Here, the ejection element row on the left side in FIGS. 3A to 3C will be referred to as a first ejection element row and the ejection element row on the right side therein will be referred to as a second ejection element row for the sake of convenience. Note that the wiring 205 for supplying the electric power to the multiple piezoelectric elements 6 is also formed at the vibrating board 202 (see FIG. 7B).

The liquid supplying board 203 is provided with a first common supply flow channel 17 for supplying the ink to the multiple pressure chambers 5 of the first ejection element row in common, and a second common supply flow channel 19 for supplying the ink to the multiple pressure chambers 5 of the second ejection element row in common. Meanwhile, the liquid supplying board 203 is provided with a common collection flow channel 18 for collecting the ink from the multiple pressure chambers 5 of the first ejection element row and the second ejection element row in common. The first common supply flow channel 17, the second common supply flow channel 19, and the common collection flow channel 18 extend in the x direction across an array region of the ejection elements.

The liquid supplying board 203 is provided with first individual supply flow channels 7 for individually supplying the ink to the multiple pressure chambers 5 of the first ejection element row, and a second individual supply flow channels 9 for individually supplying the ink to the multiple pressure chambers 5 of the second ejection element row. Meanwhile, the liquid supplying board 203 is provided with first individual collection flow channels 8 for individually collecting the ink from the multiple pressure chambers 5 of the first ejection element row, and second individual collection flow channels 10 for individually collecting the ink from the multiple pressure chambers 5 of the second ejection element row.

The flow channel forming board 204 is provided with a first supply port 27 for supplying the ink to the first common supply flow channel 17, a second supply port 29 for supplying the ink to the second common supply flow channel 19, and a common collection port 28 for collecting the ink from the common collection flow channel 18. These ports correspond to the connection ports 15 described with reference to FIG. 2C.

The flow channel forming board 204 is provided with a first damper chamber 301, a second damper chamber 302, and a third damper chamber 303 each in a recessed shape at positions corresponding to the first common supply flow channel 17, the common collection flow channel 18, and the second common supply flow channel 19, respectively. The first damper chamber 301, the second damper chamber 302, and the third damper chamber 303 extend in the x direction and are opposed to the first common supply flow channel 17, the common collection flow channel 18, and the second common supply flow channel 19, respectively, through the elastic damper member 300 in the form of a membrane.

According to the above-described configuration, the ink supplied from the first supply port 27 is routed through the first common supply flow channel 17 and the first individual supply flow channel 7, and is supplied to the pressure chamber 5 of the first ejection element row. The ink not ejected from the pressure chamber 5 is routed through the first individual collection flow channel 8 and the common collection flow channel 18, and is collected from the common collection port 28 to an external unit. On the other hand, the ink supplied from the second supply port 29 is routed through the second common supply flow channel 19 and the second individual supply flow channel 9, and is supplied to the pressure chamber 5 of the second ejection element row. The ink not ejected from the pressure chamber 5 is routed through the second individual collection flow channel 10 and the common collection flow channel 18, and is collected from the common collection port 28 to the external unit.

As described above, in the liquid ejection head of the present embodiment, the common flow channel and the damper chamber of the supply system are provided one by one to each of the two ejection element rows. On the other hand, the single common flow channel and the single damper chamber of the collection system are provided in common to the two ejection element rows. Since the first ejection element row and the second ejection element row share the common flow channel of the collection system, the first ejection element row and the second ejection element row can be brought closer in the y axis direction. As a consequence, it is possible to downsize the liquid ejection board 2, thereby reducing the size of the liquid ejection head 1 and consequently the size of the printing apparatus 101 as a whole.

In the meantime, a pressure wave is generated in the pressure chamber 5 in a case where a voltage is applied to the piezoelectric element 6 and the ink in the pressure chamber 5 is ejected from the ejection port 3. This pressure wave is propagated to the first common supply flow channel 17 or the second common supply flow channel 19 as well as to the common collection flow channel 18, and is absorbed by the damper member 300 that is deformed to the damper chamber side.

To be more precise, the pressure wave propagated to the first common supply flow channel 17 is absorbed by the damper member 300 that is deformed to the first damper chamber 301 side. The pressure wave propagated to the second common supply flow channel 19 is absorbed by the damper member 300 that is deformed to the third damper chamber 303 side. The pressure wave propagated to the common collection flow channel 18 is absorbed by the damper member 300 that is deformed to the second damper chamber 302. In the present disclosure, a set of one damper chamber and the damper member 300 will be referred to as a damper region. Moreover, the flow channel forming board 204 and the damper member 300 will also be collectively referred to as a damper region forming board.

Here, in the configuration of the present embodiment, the pressure wave corresponding to one ejection element row is propagated to each of the first common supply flow channel 17 and the second common supply flow channel 19, whereas the pressure waves corresponding to two ejection element rows are propagated to the common collection flow channel 18. Accordingly, in the case of the comparative example shown in FIG. 3A, there is a possibility that a sufficient damping effect is not available from the second damper chamber 302 that receives the pressure waves from two ejection element rows even in a case where a damping effect of each of the first damper chamber 301 and the third damper chamber 303 that receives the pressure wave from one of the ejection element rows is sufficient.

In addition, it has been confirmed that a pressure fluctuation due to ejection is more likely to be propagated to the collection flow channel side than to the supply flow channel side in a circulation flow channel. For this reason, the second damper chamber 302 of the comparative example shown in FIG. 3A has an insufficient damping effect and is less likely to suppress the crosstalk. Accordingly, there is a concern of an adverse effect on ejection.

Given the circumstances, the liquid ejection head of the present embodiment adopts the configuration shown in FIG. 3B. The present embodiment is different from the comparative example shown in FIG. 3A in that a width Wb of the second damper chamber 302 is set larger than a width Wa of each of the first damper chamber 301 and the third damper chamber 303 in the y direction that crosses the direction (the x direction) of array of the ejection elements. That is to say, a volume of the second damper chamber 302 corresponding to the common collection flow channel 18 having the larger number of the communicating pressure chambers 5 than those of the first common supply flow channel 17 and the second common supply flow channel 19 is set large. Thus, a movable region of the damper member 300 in the form of the membrane can be expanded and the damping effect thereof can be enhanced more than that according to the configuration of the comparative example. As a consequence, even in the case of the collection flow channel that receives the pressure waves corresponding to two ejection element rows, it is possible to obtain the sufficient damping effect, to suppress the crosstalk, and to stably carry out the normal state of ejection in the liquid ejection head as a whole.

FIGS. 7A and 7B are plan views of the respective boards constituting the liquid ejection board 2 of the present embodiment. FIG. 7A shows respective plan views of the ejection port forming board 201, the vibrating board 202, the liquid supplying board 203, and the flow channel forming board 204 viewed in the direction of ejection of the ink. Meanwhile, FIG. 7B shows perspective views illustrating back surfaces of the ejection port forming board 201, the vibrating board 202, the liquid supplying board 203, and the flow channel forming board 204 viewed in the same direction.

As shown in FIG. 7A, in the flow channel forming board 204, the width Wb in the y direction of the second damper chamber 302 is set larger than the width Wa in the y direction of the first damper chamber 301 and the third damper chamber 303 (Wb > Wa).

According to the above-described embodiment, the damper chamber of the collection flow channel that receives the pressure waves corresponding to two ejection element rows is set larger than the damper chamber of the supply flow channel that receives the pressure wave corresponding to one ejection element row. In this way, it is possible to provide the liquid ejection head which can stably carry out normal ejection while realizing reduction in size.

Here, the common flow channel in the center having the larger number of the communicating pressure chambers 5 is used as the common collection flow channel 18 for collection in FIG. 3B. Instead, this flow channel may be used as the common supply flow channel for supplying the ink to the first ejection element row and the second ejection element row in common. That is to say, the direction of circulation of the ink in FIG. 3B may be reversed. In this case as well, it is possible to suppress the crosstalk and to stably carry out the normal state of ejection by setting the damper chamber of the common flow channel that receives the pressure waves corresponding to two ejection element rows larger than the damper chamber of the supply flow channel that receives the pressure wave corresponding to one ejection element row. Meanwhile, the width of the second damper chamber 302 can be kept smaller than that in FIG. 3B by using the common flow channel corresponding to the two ejection element rows as the supply common flow channel that is less susceptible to the pressure waves.

### Second Embodiment

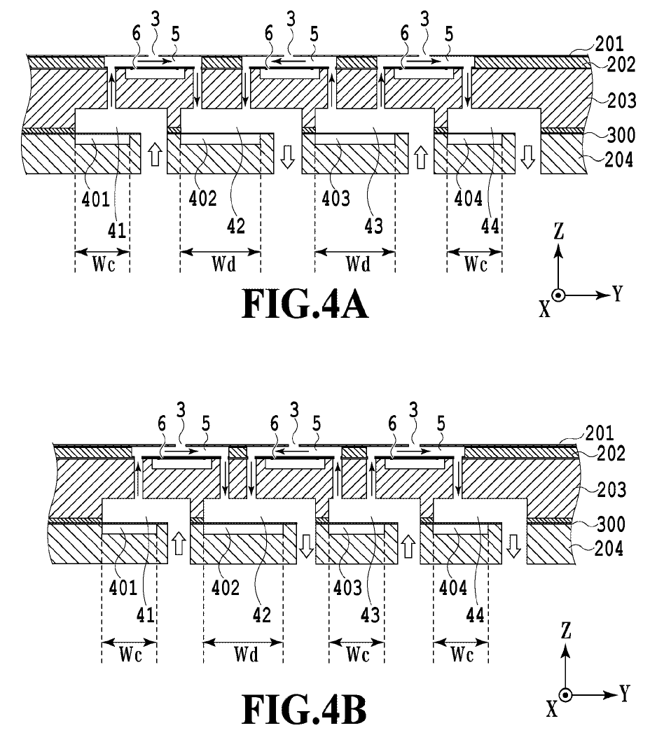

FIGS. 4A and 4B are diagrams to explain a liquid ejection board of a second embodiment. FIG. 4A is a cross-sectional view of the liquid ejection board 2 of the second embodiment. There are three ejection port rows in FIG. 4A. Here, an ejection element row on the left side in FIGS. 4A and 4B will be referred to as a first ejection element row, an ejection element row in the center therein will be referred to as a second element row, and an ejection element row on the right side therein will be referred to as a third ejection element row for the sake of convenience. A common flow channel that supplies the ink to the first ejection element row will be referred to as a first common supply flow channel 41 and a common flow channel that collects the ink from the first ejection element row and the second ejection element row will be referred to as a first common collection flow channel 42. Meanwhile, a common flow channel that supplies the ink to the second ejection element row and the third ejection element row will be referred to as a second common supply flow channel 43 and a common flow channel that collects the ink from the third ejection element row will be referred to as a second common collection flow channel 44. In addition, damper chambers formed at positions corresponding to the first common supply flow channel 41, the first common collection flow channel 42, the second common supply flow channel 43, and the second common collection flow channel 44 will be referred to as a first damper chamber 401, a second damper chamber 402, a third damper chamber 403, and a fourth damper chamber 404, respectively.

In the present embodiment, a width Wd of the second damper chamber 402 and the third damper chamber 403 is set larger than a width Wc of the first damper chamber 401 and the fourth damper chamber 404. That is to say, volumes of the second damper chamber 402 and the third damper chamber 403 corresponding to the first common collection flow channel 42 and the second common supply flow channel 43 having the relatively larger number of the communicating pressure chambers 5 are set larger than those of the first damper chamber 401 and the fourth damper chamber 404. Thus, a movable region of the damper member 300 in the form of the membrane can be expanded in the common flow channel that receives the pressure waves corresponding to two ejection element rows, so that a sufficient damping effect can be realized. That is to say, it is possible to stably carry out the normal state of ejection in the liquid ejection head as a whole while realizing reduction in size thereof.

FIG. 4B is a view showing a modified example of the second embodiment. As compared to FIG. 4A, the width of the third damper chamber 403 is changed from the width Wd to the width Wc. As has been described already, the pressure fluctuation due to ejection is more likely to be propagated to the collection flow channel side than to the supply flow channel side. This is because a circulating flow from the supply flow channel toward the collection flow channel is generated in a circulation head by setting an internal pressure of the collection flow channel lower than that of the supply flow channel, and the pressure from the pressure chamber 5 is therefore more likely to be propagated to the collection flow channel side having the lower pressure. In other words, even in the case where the second common supply flow channel 43 communicates with two ejection element rows, the effect of the pressure fluctuation does not appear very much in the second common supply flow channel 43 as compared to the first common collection flow channel 42 that similarly communicates with two ejection element rows since the second common supply flow channel 43 is located on the supply side relative to the pressure chamber 5. In this case, the width of the third damper chamber 403 may be set to the width Wc as shown in FIG. 4B so as to give priority to the reduction in size rather than the damping effect.

On the other hand, in a case where the effect of the pressure fluctuation in the first common collection flow channel 42 is quite large, the first common collection flow channel 42 may further be increased in size in return for the reduction in size of the second common supply flow channel 43 so as to give priority to further improvement in the damping effect rather than the reduction in size. In any case, the size of each common flow channel may be adjusted as appropriate depending on the magnitude of the pressure fluctuation received by the common flow channel and on the demand for the reduction in size thereof.

### Third Embodiment

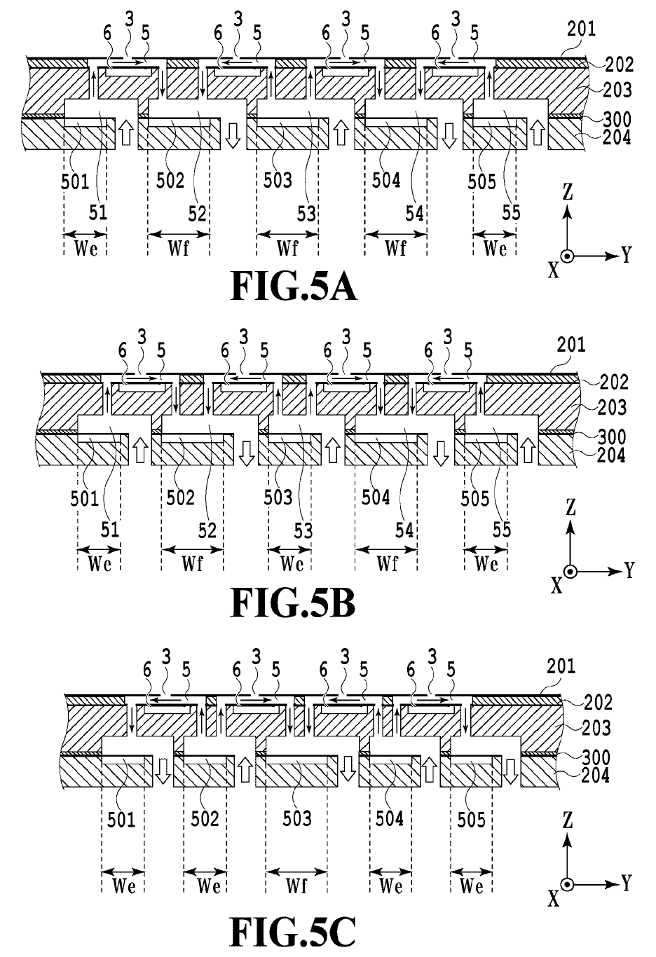

FIGS. 5A to 5C are diagrams to explain a third embodiment. FIG. 5A is a cross-sectional view of the liquid ejection board 2. In the third embodiment, there are four ejection port rows as shown in FIG. 5A. Here, the ejection element rows will be referred to as a first ejection element row, a second element row, a third ejection element row, and a fourth ejection element row sequentially from the left side in FIGS. 5A to 5C for the sake of convenience. A common flow channel that supplies the ink to the first ejection element row will be referred to as a first common supply flow channel 51, a common flow channel that collects the ink from the first ejection element row and the second ejection element row will be referred to as a first common collection flow channel 52, and a common flow channel that supplies the ink to the second ejection element row and the third ejection element row will be referred to as a second common supply flow channel 53. Meanwhile, a common flow channel that collects the ink from the third ejection element row and the fourth ejection element row will be referred to as a second common collection flow channel 54, and a common flow channel that supplies the ink to the fourth ejection element row will be referred to as a third common supply flow channel 55. In addition, damper chambers formed at positions corresponding to the first common supply flow channel 51, the first common collection flow channel 52, and the second common supply flow channel 53 will be referred to as a first damper chamber 501, a second damper chamber 502, and a third damper chamber 503, respectively. Moreover, damper chambers formed at positions corresponding to the second common collection flow channel 54 and the third common supply flow channel 55 will be referred to as a fourth damper chamber 504 and a fifth damper chamber 505, respectively.

In the present embodiment, a width Wf of the second damper chamber 502, the third damper chamber 503, and the fourth damper chamber 504 is set larger than a width We of the first damper chamber 501 and the fifth damper chamber 505. That is to say, volumes of the second damper chamber 502, the third damper chamber 503, and the fourth damper chamber 504 corresponding to the first common collection flow channel 52, the second common supply flow channel 53, and the second common collection flow channel 54 having the larger number of the communicating pressure chambers 5 are set larger than those of the first damper chamber 501 and the fifth damper chamber 505. Thus, a movable region of the damper member 300 in the form of the membrane can be expanded, so that the damping effect can be enhanced. As a consequence, a sufficient damping effect can be realized in the common flow channel that receives the pressure waves corresponding to two ejection element rows. That is to say, it is possible to stably carry out the normal state of ejection while realizing reduction in size of the liquid ejection board 2 provided with four ejection element rows.

FIG. 5B is a diagram showing a first modified example of the third embodiment. As compared to FIG. 5A, the width of the third damper chamber 503 is changed from the width Wf to the width We. Since the second common supply flow channel 53 is located on the supply side relative to the pressure chamber 5, the effect of the pressure fluctuation does not appear very much in the second common supply flow channel 53 in some cases as compared to the first common collection flow channel 52 and the second common collection flow channel 54. In this case, the width of the third damper chamber 503 may be set smaller than the width Wf as shown in FIG. 5B so as to give priority to the reduction in size rather than the damping effect.

FIG. 5C is a diagram showing a second modified example of the third embodiment. The direction of circulation of the ink is reversed from FIG. 5A. In this case, the common flow channel in the center that has been defined as the second common supply flow channel 53 in FIGS. 5A and 5B is the only common flow channel of the collection system communicating with two ejection element rows. Accordingly, in this modified example, the width of only the third damper chamber 503 corresponding to the common flow channel in the center with the highest concern of the pressure fluctuation is set to the width Wf while the width of the remaining four damper chambers is set to the width We (<Wf). In this way, it is possible to realize the liquid ejection board 2 even in a smaller size as compared to FIGS. 5A and 5B while achieving the favorable damping performances.

### Fourth Embodiment

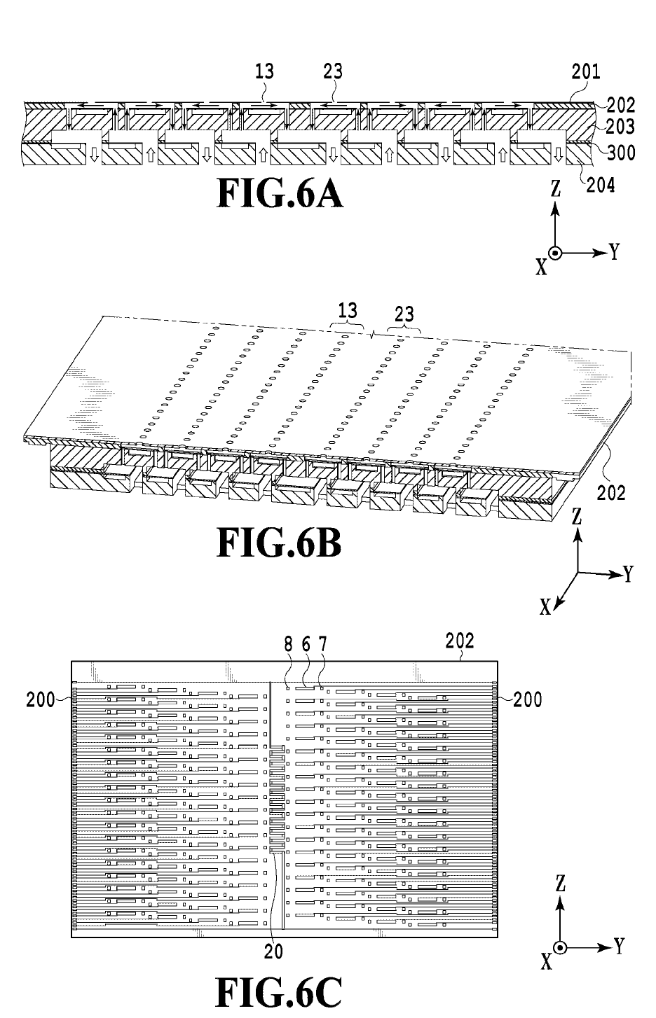

FIGS. 6A to 6C are diagrams to explain a fourth embodiment. FIG. 6A is a cross-sectional view of the liquid ejection board 2. FIG. 6B is a cross-sectional perspective view of the liquid ejection board 2. FIG. 6C is a plan view of the vibrating board 202 viewed from a back side (an opposite direction to the direction of ejection of the ink).

In the present embodiment, eight ejection port rows are arranged in parallel in the y direction. In the case where many ejection port rows are present as described above, the terminals 200 for receiving the signals and electric power to be supplied to the respective ejection element rows may be provided at two end portions (two end portions in the y direction) of the liquid ejection board 2 as shown in FIG. 6C. Here, a temperature sensor 20 for obtaining an average temperature in the liquid ejection board 2 is preferably provided in the center of the liquid ejection board 2 in order not to interfere with other wiring. In this case, an interval between two ejection element rows located in the center of the liquid ejection board 2 is wider than intervals between other ejection element rows. In FIGS. 6A and 6B, the above-described two ejection element rows are indicated as a first ejection element row 13 and a second ejection element row 23.

In the liquid ejection board 2 as described above, the common flow channel shared by the first ejection element row 13 and the second ejection element row 23 can secure the width in the y direction more easily than other common flow channels due to the structural reason. Accordingly, in the present embodiment, the direction of circulation of the ink is controlled such that the common flow channel shared by the first ejection element row 13 and the second ejection element row 23 serves as the common collection flow channel for the first ejection element row 13 and the second ejection element row 23. The direction of circulation of the ink is indicated in FIG. 6A.

As described above, in the liquid ejection board 2 provided with many ejection element rows, it is possible to stably carry out the normal ejection while suppressing an increase in size of the board by setting the flow channel that can structurally secure the large damper space as the common collection flow channel for two ejection element rows.

### Other Embodiments

The above-described embodiments have discussed the example of the liquid ejection head of the circulation type provided with the common supply flow channel and the common collection flow channel. However, the liquid ejection board of the present disclosure is not limited to the above-described configuration. For example, even in a case where all the flow channels are supply flow channels without provision of a collection flow channel, it is possible to exert the effects of the present disclosure by setting the damper chamber of the common supply flow channel shared by two ejection element rows larger than the damper chamber of the common supply flow channel corresponding to one ejection element row. That is to say, the respective common supply flow channels can obtain the damping effects suitable for the magnitudes of the pressure fluctuations, and it is possible to stably carry out the normal ejection in the liquid ejection head as a whole.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145597, filed August 27, 2024, which is hereby incorporated by reference herein in its entirety.

What is claimed is:

1. A liquid ejection head comprising lamination in an enumerated order of:
an ejection port forming board including a plurality of ejection ports configured to eject a liquid;
a pressure chamber forming board including a plurality of pressure chambers provided corresponding to the respective ejection ports and configured to contain the liquid to be ejected from the ejection ports;
a liquid supplying board including
a first common flow channel communicating with a first number of the pressure chambers in common, and
a second common flow channel communicating with a second number of the pressure chambers in common, the second number being smaller than the first number; and
a damper region forming board including
a first damper region for reducing a pressure fluctuation in the first common flow channel, and
a second damper region for reducing a pressure fluctuation in the second common flow channel, wherein
the first damper region is larger than the second damper region.

2. The liquid ejection head according to claim 1, further comprising:
a first ejection element row including
ejection elements each provided with the ejection port and the pressure chamber and arrayed in a first direction; and
a second ejection element row disposed in a second direction crossing the first direction relative to the first ejection element row, and including the ejection elements arrayed in the first direction, wherein
the first common flow channel communicates with the pressure chambers included in the first ejection element row and the second ejection element row in common, and
the second common flow channel communicates with the pressure chambers of any one of the first ejection element row and the second ejection element row in common.

3. The liquid ejection head according to claim 2, wherein a width of the first damper region is larger than a width of the second damper region in the second direction.

4. The liquid ejection head according to claim 2, wherein
the first common flow channel is a flow channel for collecting the liquid from the pressure chambers included in the first ejection element row and the second ejection element row in common, and
the second common flow channel is a flow channel for supplying the liquid to the pressure chambers of any one of the first ejection element row and the second ejection element row in common.

5. The liquid ejection head according to claim 2, wherein
the first common flow channel is a flow channel for supplying the liquid to the pressure chambers included in the first ejection element row and the second ejection element row in common, and
the second common flow channel is a flow channel for collecting the liquid from the pressure chambers of any one of the first ejection element row and the second ejection element row in common.

6. The liquid ejection head according to claim 2, wherein
the first ejection element row and the second ejection element row are provided to the liquid ejection board,
terminals for driving the ejection elements are disposed at two end portions in the second direction of the liquid ejection board, and
a sensor for detecting a temperature of the liquid ejection board is disposed at a position located between the first ejection element row and the second ejection element row and corresponding to the first common flow channel.

7. The liquid ejection head according to claim 6, wherein
the liquid ejection board includes lamination of
a first board provided with the pressure chambers, and
a second board provided with the first common flow channel, the second common flow channel, and individual flow channels individually connecting the first common flow channel and the second common flow channel to the respective pressure chambers, and
in the second board, the first common flow channel and the second common flow channel are provided to an opposite surface of a surface connected to the pressure chambers.

8. The liquid ejection head according to claim 1, wherein
the first damper region is formed from a hollow first damper chamber, and a flexible damper member, and
the second damper region is formed from a second damper chamber having a smaller volume than a volume of the first damper chamber, and a flexible damper member.

9. The liquid ejection head according to claim 1, wherein the liquid ejection head is an ink jet printing head configured to print an image on a print medium by ejecting an ink.

10. A liquid ejection board comprising lamination in an enumerated order of:
an ejection forming board including a plurality of ejection ports configured to eject a liquid;
a pressure forming board including a plurality of pressure chambers corresponding to the respective ejection ports and configured to contain the liquid to be ejected from the ejection ports;
a liquid supplying board provided with
a first common flow channel communicating with a first number of the pressure chambers, and
a second common flow channel communicating with a second number of the pressure chambers being smaller than the first number; and
a damper region forming board provided with
a first damper region for reducing a pressure fluctuation in the first common flow channel, and
a second damper region for reducing a pressure fluctuation in the second common flow channel, wherein
the first damper region is larger than the second damper region.
